(19) United States
(12) Patent Application Publication
(10) Pub. No.: US 2007/0113470 A1
(43) Pub. Date: May 24, 2007

(54) Plant support apparatus

(75) Inventor: Gino Mucci, Kingsville (CA)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Mucci Farms Ltd., Kingsville, CA (US)

(21) Appl. No.: 11/602,535

(22) Filed: Nov. 21, 2006

(30) Foreign Application Priority Data
Nov. 21, 2005 (CA) 2527384

(51) Int. Cl. A01G 17/06

(52) U.S. Cl. 47/44

(57) ABSTRACT

An apparatus for releasably supporting portions of a plant comprising at least one clip, at least one hook, at least one arch and at least one support. The apparatus is made of naturally decaying and clean-burning material. The at least one clip comprises a body having an inner opening, a gap in the body to allow a portion of the plant into the opening and at least one slot extending inwardly from an inner edge of the body for receiving and releasably retaining a portion of the support within the slot.

### CROSS REFERENCE TO RELATED APPLICATIONS

This application claims priority under 35 U.S.C. §119 to Canadian Patent Application No. 2,527,384 entitled “Plant Support Apparatus” filed Nov. 21, 2005 , the disclosure of which is hereby incorporated by reference in its entirety.

### FIELD OF THE INVENTION

The present invention relates to apparatus for supporting a plant or plants.

### BACKGROUND OF THE INVENTION

Vine plants, such as tomato vines, are commonly grown in large greenhouse operations and must be supported in order to arrange a large number of plants without damaging the vine fruit. Supports such as strings or wires are commonly used, although support poles or the like may also be used.

In commercial farming operations, large volumes of waste must be disposed of between crops in an environmentally safe way without considerable expense of money and/or time. To this end, various products are used to support plants during growth which are made of various polymer materials. These products must be manually separated from the plant materials once the crop has been harvested. While these products may be recycled, the time involved in the separation process is often prohibitive. Moreover, increasingly strict environmental policies for the burning of farm waste have forced farming operations to dispose of their waste that includes these support products at landfill sites, at significant cost.

These support products include vine clips which are used to attach portions of plants to strings or support wires. Examples of vine clips are disclosed in U.S. Pat. No. 5,349,779 (Ben-Dror), U.S. Pat. No. 3,494,072 (Olsen), Dutch patent No. 184038 (Kudelstaart), Dutch patent application No. 8402815 and at www.paskal.biz. These vine clips comprise an annular body comprised of two semi-annular halves pivotally connected together by a flexible coupling integral with the annular body at one end and releasably clasped together at the other end. In order to attach the clip to the vine, the two halves must be unclasped and pivoted apart. The string or support wire may be secured within the flexible coupling, or otherwise, (e.g. if it is too thick) looped into the clip itself. These clips are not only cumbersome to use, but are also subject to wear and tear due to repeating bending stresses on the flexible coupling. In addition, these clips are made of polymer materials which cannot be disposed of by burning in accordance with environmental regulations and are not biodegradable. They must therefore be manually separated from farm waste.

Truss hooks and arch supports (sometimes referred to as half-moon supports) are used to provide support to the tomato cluster itself and to the portion of the stem from which the cluster is growing, respectively. Examples of truss hooks and arch supports are disclosed at www.paskal.biz. Truss hooks will prevent kinking and cutting off of the nutrient flow to the developing tomatoes because holding the cluster in a more horizontal or upright position enhances fruit quality and yield. J-type hooks, such as those shown at www.paskal.biz have a pair of barbs at one end for attachment to string or support wire and a small hook at the other end that attaches to the tomato cluster. Both of these components are also made of polymer materials which cannot be disposed of by burning in accordance with environmental regulations and are not biodegradable. They must therefore be manually separated from farm waste. It should also be noted that these components are typically used in conjunction with polymer twine to which the same restrictions apply.

### SUMMARY OF THE INVENTION

According to a first aspect of an embodiment of the invention, there is provided an apparatus for releasably securing a portion of a plant to a support. The apparatus comprises a body having an inner opening, a gap in the body to allow the portion of the plant into the opening and at least one slot extending inwardly from an inner edge of the body for receiving and releasably retaining a portion of the support within the slot. The body may be substantially annular, may have varying thickness and may be substantially rigid. Preferably, the slot extends into a thickest portion of the body and is inwardly tapered.

The apparatus may further comprise means for releasably retaining the support in the slot, for example at least two teeth integral with the body wherein each of the at least two teeth extend inwardly from edges of the slot adjacent to the inner edge. These teeth may be spaced apart by a distance less than the width of the support so as to receive a portion of the support through compression of the support and/or displacement of the teeth.

Preferably, the apparatus is made of naturally decaying and clean-burning material. One such material is density board which comprises about 84% wood fiber, about 15% environmental protection mixture and about 1% paraffin wax.

According to a second aspect of an embodiment of the invention, there is provided an apparatus for releasably supporting portions of a plan, wherein the apparatus comprises at least one clip, at least one hook, at least one arch and at least one support. The apparatus is made of naturally decaying and clean-burning material. One such material is density board which comprises about 84% wood fiber, about 15% environmental protection mixture and about 1% paraffin wax.

### BRIEF DESCRIPTION OF THE DRAWINGS

An embodiment of the invention will now be described by way of example with reference to the accompanying drawings, in which:

FIG. 1 is a perspective view of an embodiment of the invention in use;

FIG. 2A is a front view of an embodiment of the invention;

FIG. 2B is a front view of an embodiment of the invention;

FIG. 2C is a perspective view of the embodiment shown in FIG. 2A in use;

FIG. 3A is a front view of part of an embodiment of the invention;

FIG. 3B is a front view of part of an embodiment of the invention;

FIG. 4A is a perspective view of part of an embodiment of the invention;

FIG. 4B is a perspective view of part of an embodiment of the invention;

FIG. 4C is a perspective view of part of an embodiment of the invention; and

FIG. 4D is a perspective view of part of an embodiment of the invention.

### DETAILED DESCRIPTION OF THE INVENTION

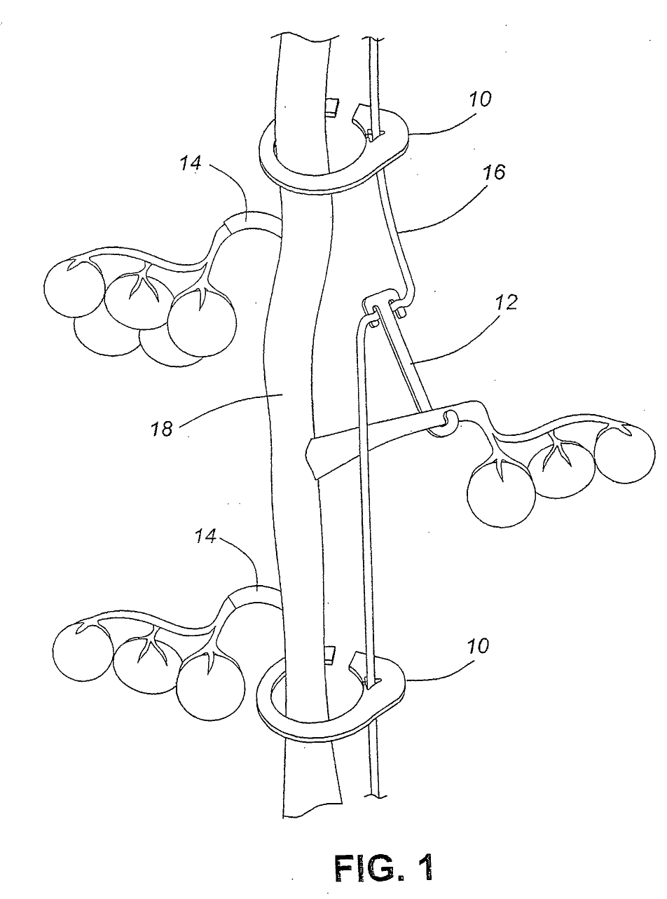

According to an embodiment of the invention, FIG. 1 illustrates an apparatus comprising at least one clip 10, at least one hook 12, at least one arch 14 and at least one support 16 for supporting various portions of a plant 18.

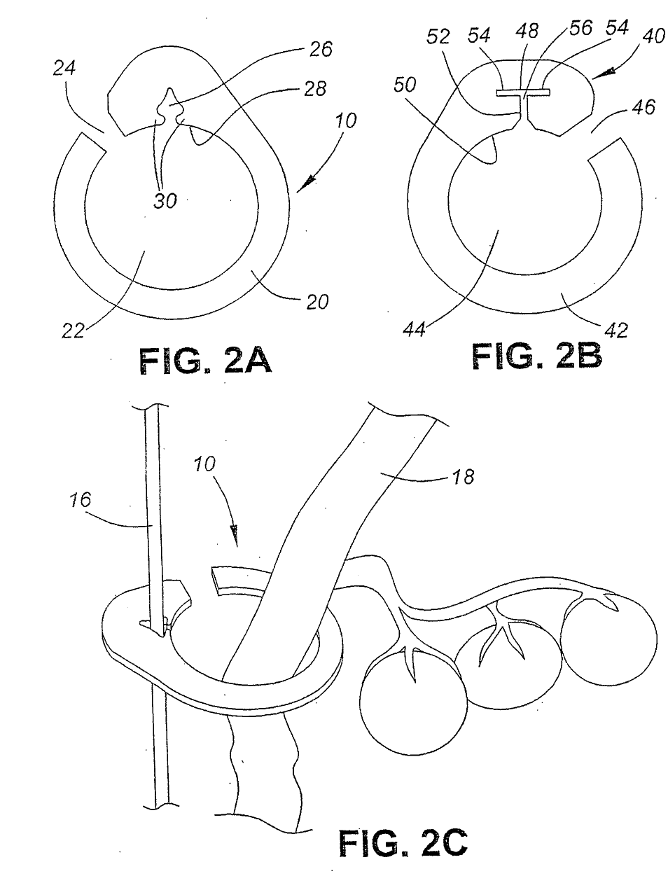

FIGS. 2A and 2C illustrate in detail the clip 10 for securing a portion of a plant 18 to a support 16. The clip 10 comprises a body 20 having an inner opening 22 and a gap 24 in the body 20 to allow the portion of the plant 18 into the inner opening 22, as shown in FIG. 2C. The support 16 may be a string or support wire, or other suitable supports for tomato plant or the like, known in the art.

A slot 26 extends inwardly from an inner edge 28 of the body 20 and receives a portion of the support 16. The slot 26 comprises means for releasably retaining the support 16 in the slot 26. In the embodiment shown in FIGS. 2A and 2C, the slot 26 tapers inwardly into a thickest portion of the body 20.

The body 20 is substantially rigid and may have varying thickness. It is made from a naturally decaying and clean-burning material, such as Density Board. Density Board comprises about 84% wood fiber, about 15% environmental protection mixture and about 1% paraffin wax. Preferably, the material is smooth so as to minimize damage to the plant. Environmental protection mixture refers to an adhesive mixture or material for binding the wood fiber together, known to those skilled in the art.

The body 20 is substantially annular. It should be noted, however, that the body 20 may be of any suitable shape. An annular shape is simply convenient for the support of plants that typically have substantially cylindrical stems.

The means for releasably retaining the support 16 in the slot 26 comprises at least two teeth 30 integral with the body 20. These teeth 30 extend inwardly from edges of the slot 26 adjacent to the inner edge 28. They are spaced apart by a distance less than the width of the support 16 so as to receive a portion of the support 16 through compression of the support 16 and/or displacement of the teeth 30.

FIG. 2B illustrates in detail another embodiment of a clip 40 for securing a portion of a plant 18 to a support 16. The clip 40 comprises a body 42 having an inner opening 44 and a gap 46 in the body 42 to allow the portion of the plant 18 into the inner opening 44, similar to as shown in FIG. 2C.

A slot 48 extends inwardly from an inner edge 50 of the body 42 and receives a portion of the support 16. The slot 48 comprises a first slot portion 52 extending inwardly from the inner edge 50 of the body 42 and at least one second slot portion 54 extending from an innermost end 56 of the first slot portion 52. The second slot portion 54 may extend generally perpendicularly from the innermost end 56 of the first slot portion 52. The slot 48 may be T-shaped, as shown in FIG. 2B or any other suitable shape.

The width of the slot 48 is less than the width of the support 16. The slot 48 receives a portion of the support 16 through compression of the support 16.

The body 42 is also substantially rigid and may have varying thickness. It is made from a naturally decaying and clean-burning material, such as Density Board. Density Board comprises about 84% wood fiber, about 15% environmental protection mixture and about 1% paraffin wax. Preferably, the material is smooth so as to minimize damage to the plant. Environmental protection mixture refers to an adhesive mixture or material for binding the wood fiber together, known to those skilled in the art.

The body 42 is also substantially annular. It should be noted, however, that the body 42 may be of any suitable shape. An annular shape is simply convenient for the support of plants that typically have substantially cylindrical stems.

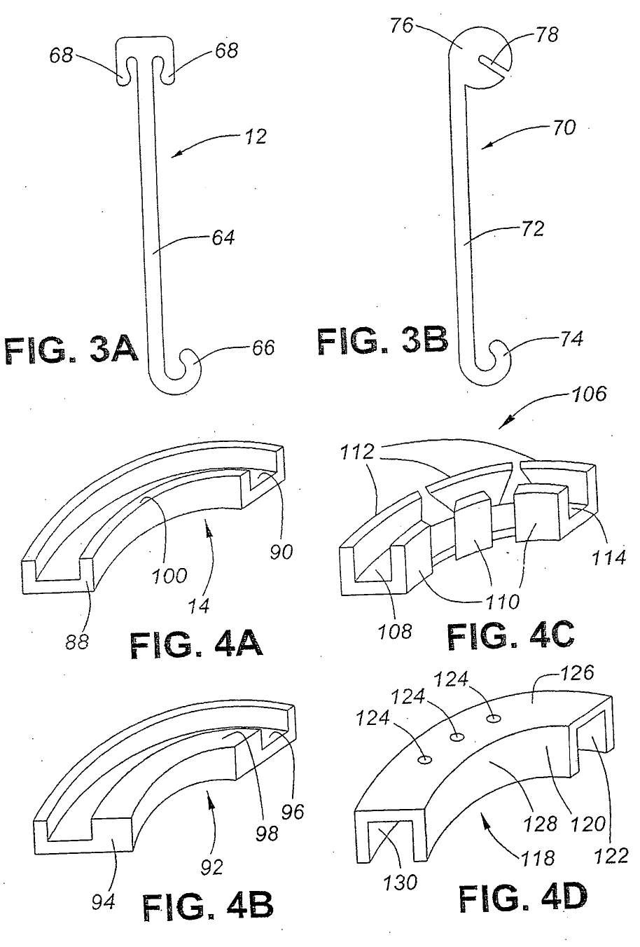

An embodiment of the hook 12 is shown in detail in FIG. 3A and comprises an elongate body 64 having a curled portion 66 at one end and at least one integral pair of barbs 68 at or near an opposite end for engaging support 16. The curled portion 66 fits around a stem or branch of the plant 18. The gaps between each one of the integral pair of barbs 68 and the elongate body 64 may be dimensioned so as to receive and engage a portion of the support 16 through compression of the support 16 and/or displacement of each of the integral pair of barbs 68.

The hook 12 is substantially rigid and is made from a naturally decaying and clean-burning material. A suitable material is Density Board comprising about 84% wood fiber, about 15% environmental protection mixture and about 1% paraffin wax. Preferably, the material is smooth so as to minimize damage to the plant.

FIG. 3B illustrates another embodiment of a hook 70 for releasably securing a portion of a plant to a support. The hook 70 comprises an elongate body 72 having a curled portion 74 at one end for engaging a portion of the plant 18 and a enlarged portion 76 at an opposite end. A slot 78 extends into the enlarged portion 76 for receiving and releasably retaining a portion of the support 18 within the slot 78. Of course, more than one slot could extend into the enlarged portion. The enlarged portion is preferably generally circular. The width of the slot 78 is less than the width of the support 16 so that the slot 78 receives a portion of the support 16 through compression of the support 16. The slot 78 may be angled at approximately 45 degrees from the elongate support, as shown. Of course, any suitable angle may be used.

FIG. 4A illustrates an arch 14 having a generally curved body 88. The body 88 comprises a groove 90 for receiving a portion of a plant 18. Arch 14 may be used to support in a preferred orientation the portion of the stem of the plant 18 from which the cluster is growing during flowering.

The arch 14 is substantially rigid and is made from a naturally decaying and clean-burning material. A suitable material is Density Board comprising about 84% wood fiber, about 15% environmental protection mixture and about 1% paraffin wax. Preferably, the material is smooth so as to minimize damage to the plant. It is not necessary to implement gaps and/or holes in the arch structure as the use of naturally decaying and clean-burning material typically allows for ventilation through the material itself.

FIG. 4B illustrates another embodiment of an arch 92 similar to the arch 14 shown in FIG. 4B. The arch 92 has a generally curved body 94 having a groove 96 for receiving a portion of a plant 18. Arch 92 may also be used to support in a preferred orientation the portion of the stem of the plant 18 from which the cluster is growing during flowering. A first edge portion 98 of the arch 92 is thicker than a first edge portion 100 of the arch 14.

The arch 92 is also substantially rigid and is made from a naturally decaying and clean-burning material. A suitable material is Density Board comprising about 84% wood fiber, about 15% environmental protection mixture and about 1% paraffin wax. Preferably, the material is smooth so as to minimize damage to the plant.

FIG. 4C illustrates another embodiment of an arch 106 comprising a generally curved body 108 having a plurality of extensions 110 and 112 extending from first and second edges, respectively. The extensions 110 and 112 define a groove 114 for receiving a portion of a plant 18. These extensions 110,112 may be arranged perpendicular to the body 108 (or at any suitable angle). These extensions may be spaced apart so as to allow for additional ventilation. Arch 106 may also be used to support in a preferred orientation the portion of the stem of the plant 18 from which the cluster is growing during flowering.

The arch 106 is also substantially rigid and is made from a naturally decaying and clean-burning material. A suitable material is Density Board comprising about 84% wood fiber, about 15% environmental protection mixture and about 1% paraffin wax. Preferably, the material is smooth so as to minimize damage to the plant.

FIG. 4D illustrates another embodiment of an arch 118 having a generally curved body 120. The body 120 comprises a groove 122 for receiving a portion of a plant 18. A plurality of holes 124 are located in a third edge portion 126 of the arch 126 to allow for additional ventilation. Of course, the holes 124 could also be located in a first edge portion 128 or a second edge portion 130. Arch 118 may also be used to support in a preferred orientation the portion of the stem of the plant 18 from which the cluster is growing during flowering.

The support 16 may be naturally decaying and clean-burning string, such as cotton string.

In use, the plant 18 is proximate to a suitable support 16, as illustrated in FIG. 1. At least one clip 10 and at least one hook 12 may engage proximate portions of the plant 18 and the support 16 in order to hold the plant 18 in a preferred orientation relative to the support 16. At least one arch 14 may engage a portion of the plant 18 in order to hold the plant in a preferred orientation. Referring to the embodiment illustrated in FIG. 1, two of the clips 10 engage respective portions of the support 16 and receive respective portions of the plant 18. Portions of the stem of the plant 18 are thus secured to the support 16. Also in the embodiment illustrated in FIG. 1, a hook 12 engages support 16 between the body 32 and each of the integral pair of barbs 36. The curled end 34 fits around and engages a portion of the stem of the plant, shown in FIG. 1 as the portion which supports a cluster of tomatoes.

FIG. 1 also illustrates two of the arches 14 supporting portions of the plant 18, specifically portions of the plant where the stems supporting respective clusters of tomatoes branch out from the main stem of the plant 18.

While FIG. 1 illustrates hook 12 and arches 14 in use, it should be understood that hook 70 could be used in the same way as hook 12 and arches 92, 106 and 118 could be used in the same way as arch 14.

While the invention has been described in detail in the foregoing specification, it will be understood by those skilled in the art that variations may be made without departing from the spirit and scope of the invention, being limited only by the appended claims.

The invention claimed is:

1. An apparatus for releasably securing a portion of a plant to a support, said apparatus comprising:
a body having an inner opening;
a gap in said body to allow said portion of said plant into said opening; and at least one slot extending inwardly from an inner edge of said body for receiving and
releasably retaining a portion of said support within said slot.

2. The apparatus according to claim 1, wherein said body is substantially annular.

3. The apparatus according to claim 1, wherein said body has varying thickness.

4. The apparatus according to claim 1, wherein said slot extends into a thickest portion of said body.

5. The apparatus according to claim 1, wherein said body is substantially rigid.

6. The apparatus according to claim 1, wherein said slot has an inward tapering for retaining said support.

7. The apparatus according to claim 1, further comprising means for releasably retaining said support in said slot.

8. The apparatus according to claim 7, wherein said means for releasably retaining comprises at least two teeth integral with said body, each of said at least two teeth extending inwardly from edges of said slot adjacent to said inner edge.

9. The apparatus according to claim 8, wherein said teeth are spaced apart by a distance less than a width of said support so as to receive a portion of said support through compression of said support and/or displacement of said teeth.

10. The apparatus according to claim 1, wherein said slot comprises a first slot portion extending inwardly from an inner edge of said body and at least one second slot portion extending generally perpendicularly from an innermost end of said first slot portion.

11. The apparatus according to claim 10, wherein said a width of said slot is less than a width of said support and said slot receives a portion of said support through compression of said support.

12. The apparatus according to claim 1, wherein said apparatus is made of naturally decaying and clean-burning material.

13. The apparatus according to claim 1, wherein said apparatus is made of density board.

14. The apparatus according to claim 1, wherein said apparatus is made of a material comprising about 84% wood fiber, about 15% environmental protection mixture and about 1% paraffin wax.

15. An apparatus for releasably supporting portions of a plant, said apparatus comprising at least one clip, at least one hook, at least one arch and at least one support, wherein said apparatus is made of naturally decaying and clean-burning material.

16. The apparatus according to claim 15, wherein said at least one clip and said at least one hook each engage proximate portions of said plant and said support to hold said plant in a preferred orientation relative to said support.

17. The apparatus according to claim 15, wherein said at least one arch engages a portion of said plant to hold said plant in a preferred orientation.

18. The apparatus according to claim 15, wherein said at least one clip, said at least one hook, said at least one arch and said at least one support are made of density board.

19. The apparatus according to claim 15, wherein said at least one clip, said at least one hook, said at least one arch and said at least one support are made of a material comprising about 84% wood fiber, about 15% environmental protection mixture and about 1% paraffin wax.

20. The apparatus according to claim 15, wherein said clip comprises:
a body having an inner opening;
a gap in said body to allow said portion of said plant into said opening; and
at least one slot extending inwardly from an inner edge of said body for receiving and releasably retaining a portion of said support within said slot.

21. An apparatus for releasably securing a portion of a plant to a support, said apparatus comprising:
an elongate body having a curled portion at one end for engaging said portion of said
plant and a enlarged portion at an opposite end; and
at least one slot extending into said enlarged portion for receiving and releasably retaining a portion of said support within said slot.
